(19) United States
(12) Patent Application Publication
(10) Pub. No.: US 2020/0094363 A1
(43) Pub. Date: Mar. 26, 2020

(54) Apparatus for Removing Turnings from a Workpiece Being Machined

(71) Applicant: Tejas Tubular Products, Inc., Houston, TX (US)

(72) Inventors: Edgar Alejandro Zuniga, Spring, TX (US); Francisco Crea, Humble, TX (US)

(21) Appl. No.: 16/136,847

(22) Filed: Sep. 20, 2018

(51) Int. Cl. B23Q 11/00

(52) U.S. Cl. CPC B23Q 11/0042; B23C 2230/04

(57) ABSTRACT

An apparatus for converting elongate stringy turnings from a workpiece being machined to short chips. There is an endless conveyor carrying grapples to grab the stringy turnings and move them along the length of the conveyor and then preferably to a metal chipper assembly which converts the stringy turnings into short chips.

### FIELD OF THE INVENTION

The present invention relates to machining and, more particularly, to the removal of cuttings from a workpiece during a machining operation. More particularly, the present invention relates to an apparatus for removing elongate, stringy turnings created during machining a workpiece and to cutting the turnings into smaller chips.

### BACKGROUND OF THE INVENTION

Machining operations of various configured metal workpieces are standard throughout the world and are especially common with threaded, tubular components, e.g., tubing, casing, couplings, and the like, used in oil and gas well operations. These machining operations—as to oilfield tubulars, primarily comprise threading. A prime example is the internal threading of a tubular component such as a coupling used to connect joints of oilfield tubulars together. In general, as the cutting tool (thread inserts) being employed removes material from the workpiece cuttings known as “chips” are created. In theory, the chips are rather short, and simply fall away presenting no problem to the machining, e.g., threading operation. However, in practice these chips can become long, stringy, and curly, and create serious machining issues.

These continuous, stringy, curly-shaped cuttings or turnings have long been known as a serious problem by-product of machining operations. For example, the stringy turnings can collect themselves into bundles of razor-wire-like material (hay) that in an internal threading operation must be continuously removed from the workpiece. Further, they can wrap themselves around the cutting tool during the machining operation and slip under the tool nose, creating gouges in the workpiece.

While the formation of these stringy cuttings when using conventionally manually operated machine tools, e.g., lathes or the like, may be of slightly lesser concern since the stringy cuttings can be readily removed by the operator during their formation, there are still safety hazards because the stringy cuttings often form growing bundles which can cut the operator's skin during attempts to remove them. The problem is exacerbated when using a computer programmed or other automated machine tools, especially when the machine tools are enclosed in a housing and access to the workpiece for removing the stringy cuttings is restricted precluding safe removal of the stringy cuttings.

Computer numerically controlled (CNC) operations are pre-programmed machining steps for metal-cutting operations performed on a workpiece. A typical CNC threading machine comprises a housing in which are mounted a head stock, tool turret, and a tail stock. The head stock can comprise a jawed chuck or the like for gripping and holding the workpiece during the machining operation. To form the internal threads, a tool turret carrying an appropriate cutting tool or thread cutting insert is axially moved relative to the workpiece while the workpiece is rotating, resulting in the formation of a continuous, helical groove (thread) in the workpiece.

At present, it is not uncommon in CNC operations where internal threads are being formed for operators to stick a wire hook or the like into the housing to pull the stringy cuttings from the workpiece. Not only is this dangerous but it can increase labor costs since the operator may require a helper to remove the stringy cuttings while the operator is performing other work.

### SUMMARY OF THE INVENTION

In one aspect, the present invention relates to an apparatus useful in the machining of components, particularly components made of metal.

In another aspect, the present invention relates to an apparatus for removing elongated, stringy turnings from a workpiece being machined.

In still a further aspect, the present invention relates to an apparatus for removing stringy turnings from a workpiece during a machining operation involving the formation of internal threads in the workpiece.

In yet a further aspect, the present invention relates to the removal of stringy cuttings from a workpiece during a machining operation and the cutting of the stringy cuttings into smaller chips.

In still a further aspect, the present invention relates to a free-standing apparatus which can be used with a CNC threading machine to remove stringy cuttings resulting from internal threading of a tubular workpiece.

These and further features and advantages of the present invention will become apparent from the following detailed description, wherein reference is made to the figures in the accompanying drawings.

### BRIEF DESCRIPTION OF THE DRAWINGS

FIG. 1 is a side, elevational view, partly in section, of one embodiment of the apparatus of the present invention positioned to remove cuttings from a tubular workpiece being internally machined.

FIG. 2 is an enlarged, elevational view, partly in section, showing a portion of the conveyor used in one embodiment of the present invention.

FIG. 3 is a view similar to FIG. 2 showing more detail.

FIG. 4 is a cross-sectional view taken along the lines 4-4 of FIG. 2.

FIG. 5 is an end view taken along the lines 5-5 of FIG. 2.

FIG. 6 is an end, elevational view of one embodiment of the apparatus of the present invention.

FIG. 7 is an enlarged, side elevational view, partly in section, showing a metal chipping assembly used in one embodiment of the apparatus of the present invention and a portion of the framework used to support the apparatus of the present invention.

FIG. 8 is a top, plan view, partly in section, showing further details of the metal chipping assembly and framework shown in FIG. 7.

FIG. 9 is a side, elevational view showing a portion of an alignment assembly used in one embodiment of the apparatus of the present invention.

FIG. 10 is a view taken along the lines 10-10 of FIG. 9.

FIG. 11 is a view taken along the lines 11-11 of FIG. 9.

### DETAILED DESCRIPTION OF PREFERRED EMBODIMENTS

Although in the description which follows, the apparatus of the present invention will be shown and described with respect to the internal threading of a tubular member, e.g., a coupling, it is not so limited. Indeed, the apparatus of the present invention can be used with the machining of any workpiece wherein elongate, stringy turnings from a workpiece are produced and collect adjacent the workpiece during the machining operation, making their removal difficult and/or dangerous. A distinct feature of the apparatus of the present invention is that it can be used with a CNC threading machine wherein the interior of the workpiece can be accessed through the headstock of the CNC machine.

Generally speaking, the apparatus of the present invention, shown generally as 10, comprises a stringy turnings collecting assembly shown generally as 12, a stringy turnings chipping assembly shown generally as 14, and an intermediate conveyor assembly shown generally as 16. The apparatus 10 comprises a support framework F comprising stanchions 18 connected to a foot plate 19 which can be bolted to a floor, slab or the like. Connected to stanchions 18 is a brace 20 which also has a foot plate 22 which can likewise be bolted to a floor or slab. It can thus be seen that the apparatus of the present invention is freestanding in that it does not rely on the CNC machine, e.g., housing H, for any substantial support. Accordingly, the apparatus of the present invention can be moved from one CNC station to another as desired.

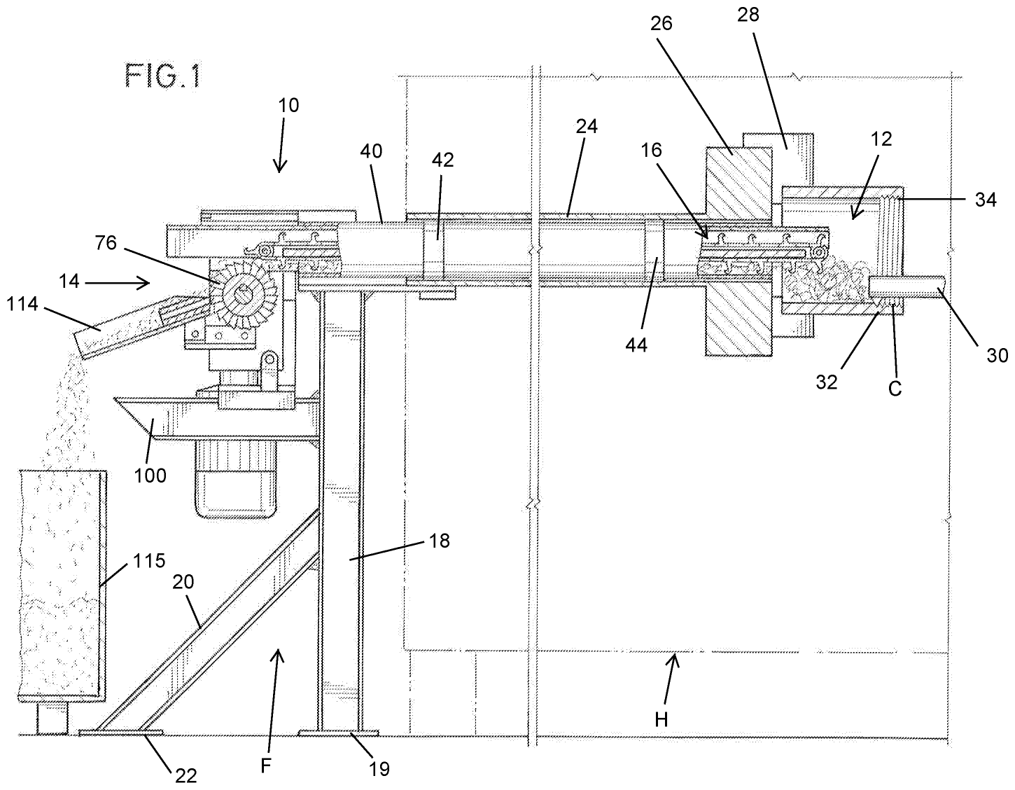

Returning then to FIG. 1, a tubular spindle 24 rotatably mounted in the CNC housing H in a well-known manner is connected to a chuck 26 having three jaws 28, only two of which are shown. Held in jaws 28 of chuck 26 is a pipe coupling blank C, coupling C rotating with rotating chuck 26 and spindle 24, respectively. Extending into one open end of coupling C is a tool turret 30 carrying a thread insert 32 for the cutting of an internal helical thread 34.

Extending through spindle 24 is an elongate support assembly, cantilevered from frame F and comprising a tube 40 carrying spaced needle bearing assemblies 42 and 44 allowing spindle 24 to freely rotate around tube 40 which is fixed against rotation as seen hereafter. As best seen in FIG. 5, the support assembly further comprises an elongate U-shaped member 42, U-shaped member 42 comprising a web 42A connecting first and second spaced legs 42B and 42C. U-shaped member 42, as seen in FIG. 5, is welded to channel irons 46, which can slidably ride in a track formed by spaced angle irons 44 which are also welded to tube 40.

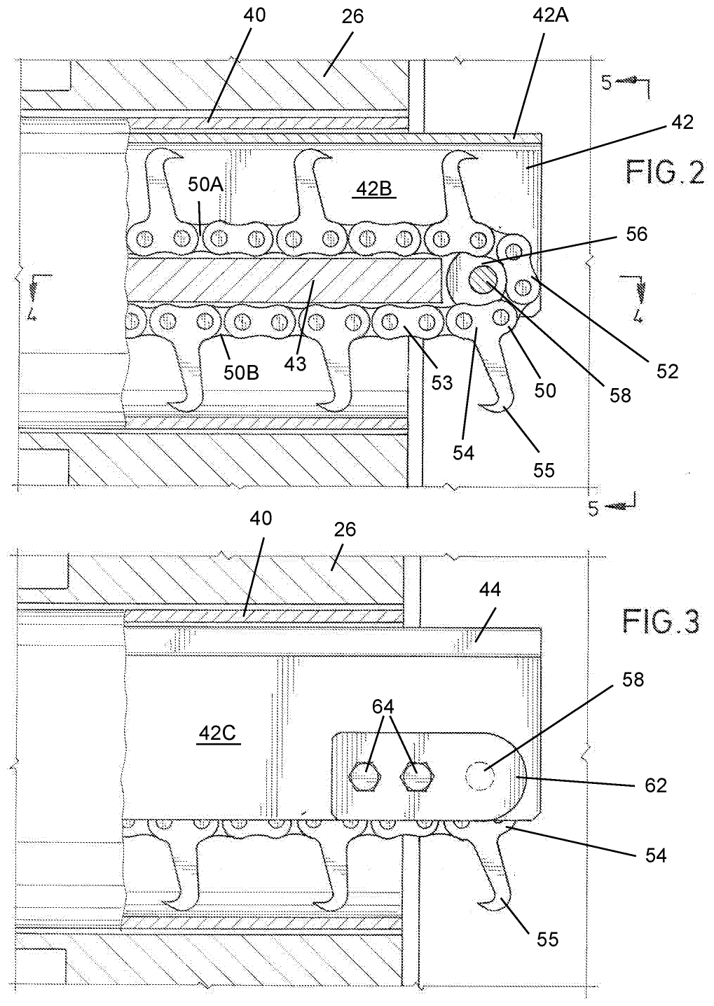

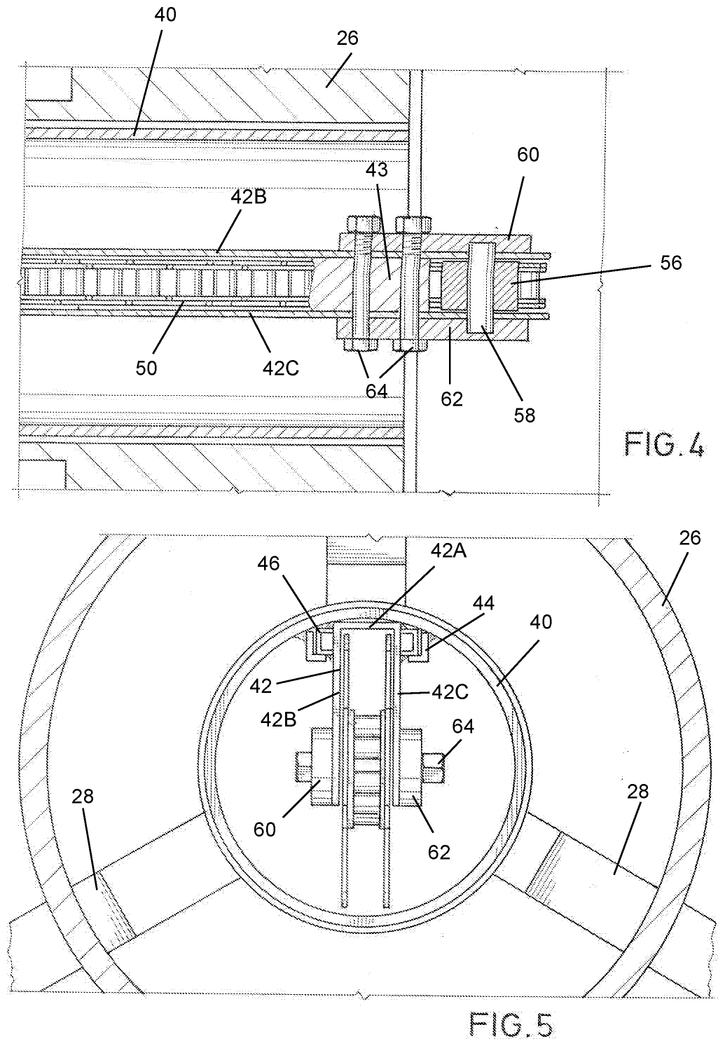

Turning now to FIG. 4, it can be seen that the conveyor assembly 16 comprises an endless roller chain 50 of typical roller chain construction, having side links, intermediate bushings and rollers as are well known to those skilled in the art. While a roller chain is used in the conveyor assembly described herein, it will be understood that other types of endless conveyors could be employed. Chain 50, as best seen in FIG. 2, includes connecting links 52, alternate links 54 of which comprise a hook formation 55. Although as shown, the hooked links 54 form alternate links, it will be understood that they could be spaced at greater intervals if desired.

Chain 50 is rotatably mounted on an idler roller 56 which comprises a central shaft 58 which is rotatably journaled in registering openings in legs 42B and 42C, as best seen in FIG. 4. Shaft 58 has its opposite ends received in counterbores formed in spaced bushing plates 60 and 62 which are connected to U-shaped member 42 through two nut/bolt combinations 64 extending through registering bores in the bushing plates 60, 62, legs 42B, 42C, and a chain support bar 43. Although not shown, chain support bar 43 can also be connected on the other end to U-shaped member 42 in a similar fashion. As best seen with reference to FIG. 2, when mounted for rotation, chain 50 has an upper strand 50A and a lower strand 50B. It will be appreciated that without chain support bar 43, upper chain strand 50A could sag.

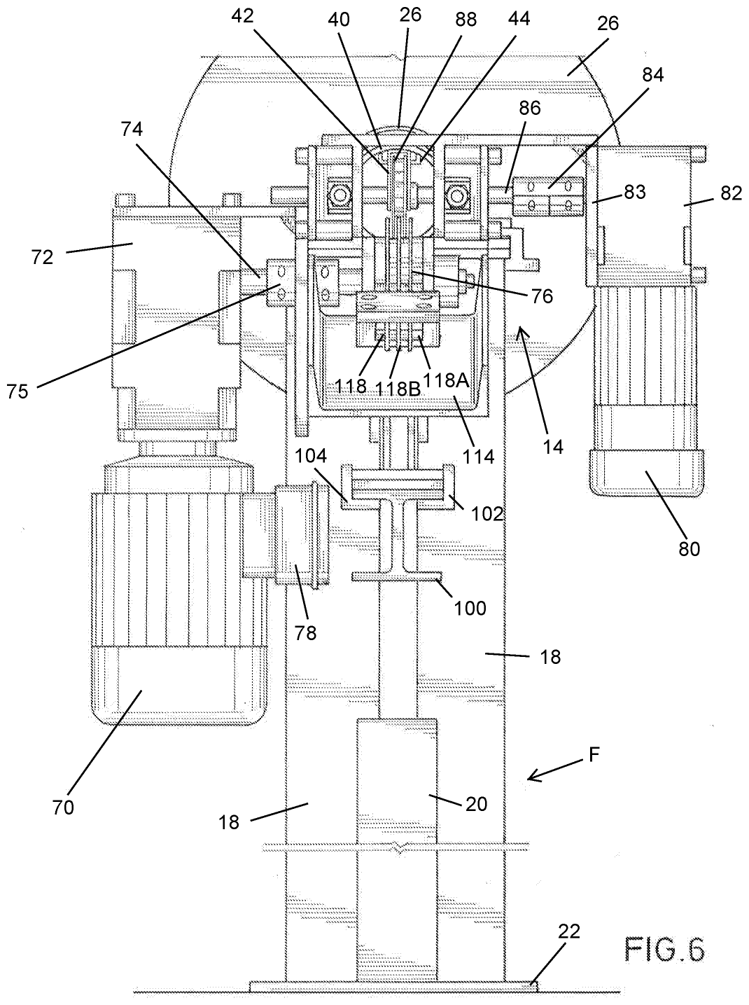

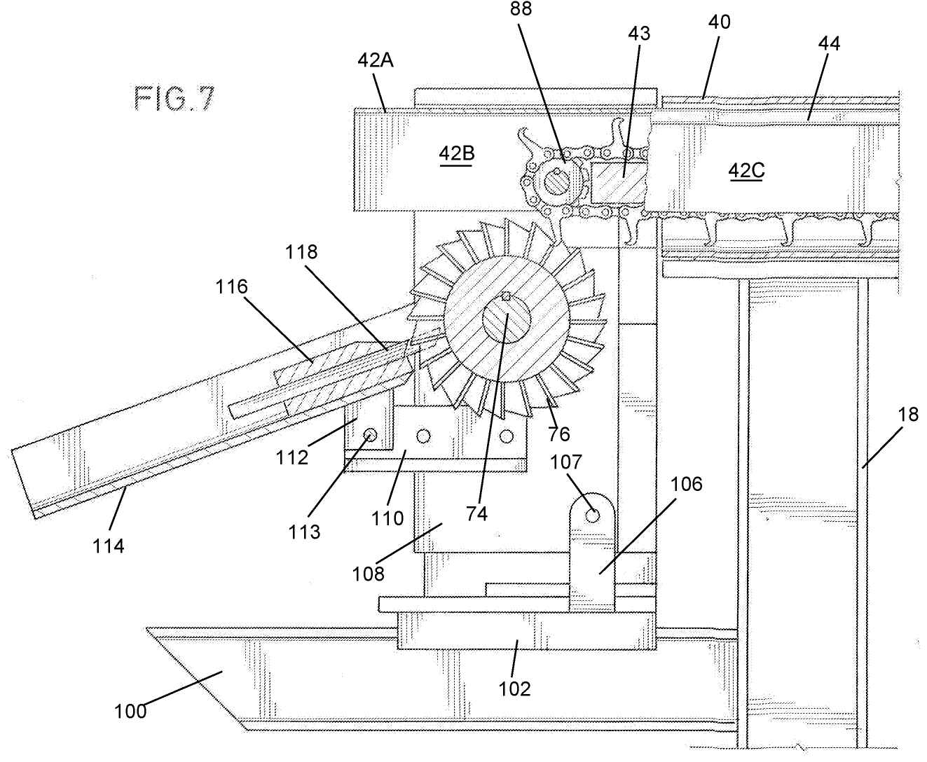

Turning now to FIGS. 6-8 and first with respect to FIG. 6 which is an end on view taken from the left side of FIG. 1, there is a motor 70 connected through a gear box 72 to a shaft 74 and shaft coupling 75 which drives a series (three) of milling wheels 76 rotatably mounted on shaft 74. Motor 70 is connected to stanchion 18 forming part of framework F. An electrical wiring box 78 is connected to motor 70. A second motor 80 is connected through a gear box 82 connected to a frame member 83 and a shaft coupling 84 to a shaft 86 which drives a sprocket 88 on which drive chain 50 is carried.

Welded to stanchions 18 is an I-beam section 100 which projects laterally outwardly, I-beam section 100 carrying slides 102, 104. Connected to slides 102, 104 are brackets 106, only one of which is shown, which are pivotally connected at 107 to frame plate 108. An arm 110 is connected to a frame member 108 and carries a post 112 on which is mounted a cutting tool holder 116, a plurality of cutting tools 118 being mounted on holder 116. Cutting tools 118 are made of wider cutting tools 118A which are interspersed among the milling wheels 76, and narrower cutting tools 118B which are positioned in line with milling wheels 76. Since post 112 is pivotally secured to arm 110, cutting tool holder 116 and cutting tools 118 can be adjusted relative to milling wheels 76. It can thus be seen that there is a wide degree of adjustability to position milling wheels 76 and cutters 118 at optimal positions relative to one another for efficient cutting of the stringy cuttings into chips. Thus, frame member 108 can pivot about pivot pin 107 and cutting tool holder 116 can pivot about pivot pin 113, altering the relative position of milling wheels 76 to maximize cutting efficiency. A chute 114 is connected to frame F and is positioned below cutting tool holder 116 and has one end sufficient close to milling wheel 76 to catch chips, the other end being positioned above a bin 115 to collect the cut chips.

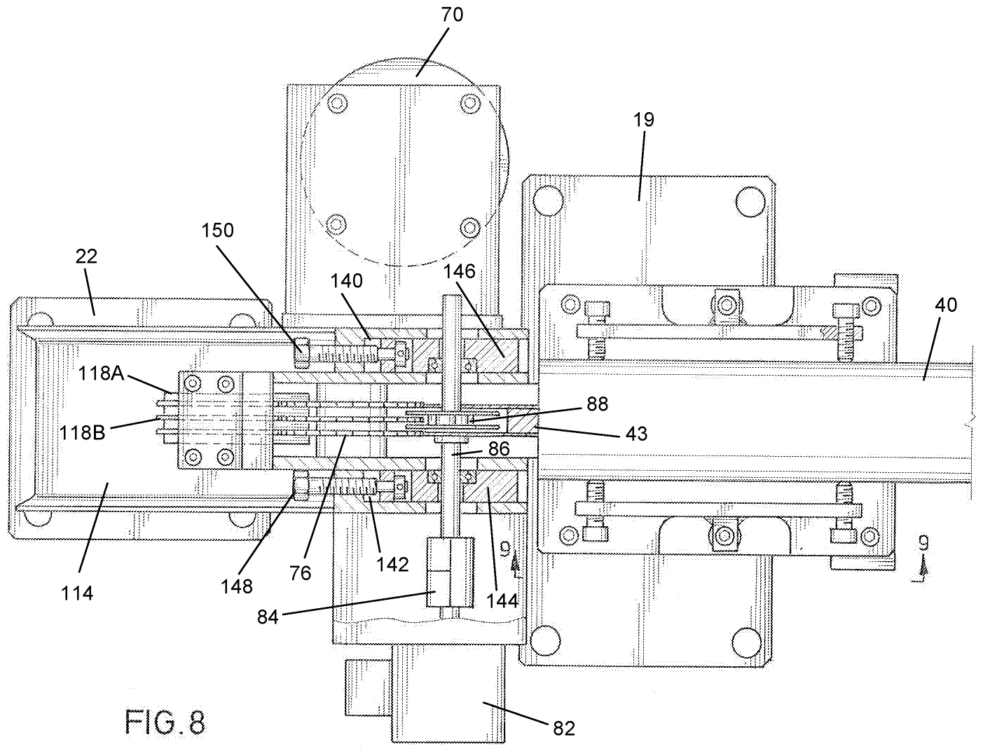

As seen in FIG. 8, a framework forms frame pockets 140 and 142 in which are slidably mounted adjustment blocks 144 and 146, respectively. Connected to adjustment blocks 144 and 146 are tensioning bolts 148 and 150, respectively. As best seen in FIG. 8, by rotation of tensioning bolts 148 and 150 blocks 144 and 146 can be moved in the desired direction so as to tension chain 50 on sprocket 88. In this regard it can be seen depending upon the direction in which tensioning bolts 148 and 150 are turned, shaft 86 can move in a left and right direction with respect to FIG. 8.

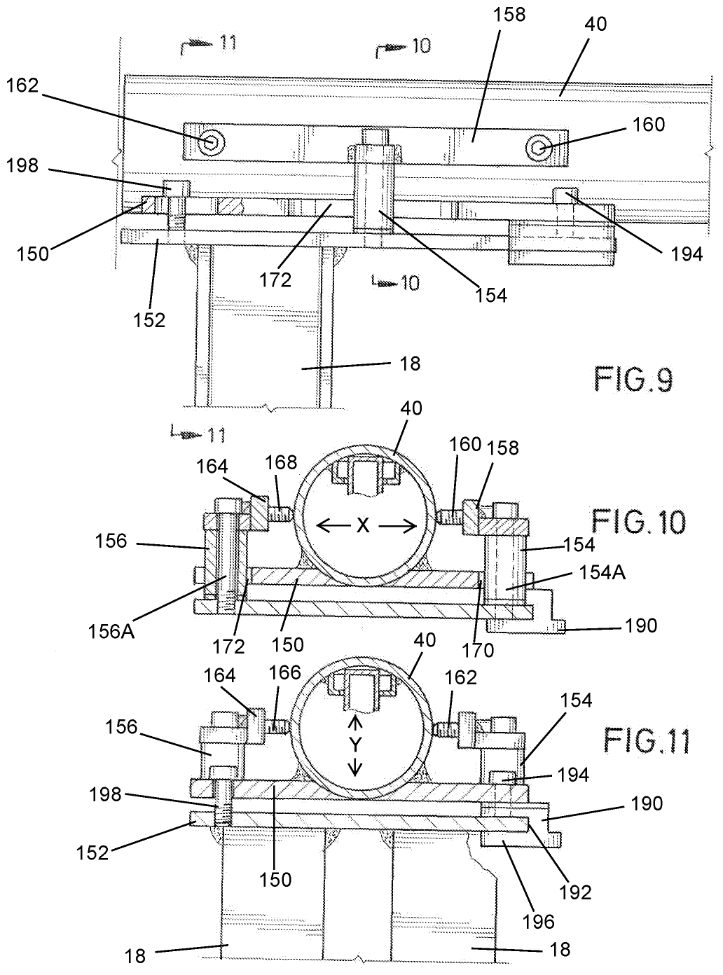

It will be recognized that tube 40 may require adjustment in an X-Y axis direction for proper alignment. To this end, reference is now made to FIGS. 9-11. As best seen in FIGS. 9 and 11, tube 40 is welded to a plate 150 which in turn is adjustably secured to a support plate 152 secured to stanchions 18. First and second spacers 154 and 156 on opposite sides of tube 40 are secured to support plate by bolts 154A and 156A, respectively. Secured to spacer 154 is a crosspiece 158 which threadedly receives axially spaced threaded bolts 160 and 162. In like fashion, there is a crosspiece 164 secured to spacer 156 which also carries threaded bolts 166 and 168.

As best seen in FIGS. 9 and 10, adjustable plate 150 has side recesses 170 and 172 which allow adjustable plate 150 to move in a left-right direction as indicated by the arrows X in FIG. 10 by adjusting the positions of bolts 160, 162, 164, and 166. Thus, if bolts 166 and 168 are moved to the left with reference to FIG. 10, bolts 160 and 162 can likewise be moved to the left, and since they engage tube 40, will shift tube 40 and adjustable plate 50 to the left.

Tube 40 can also be tilted in a generally Y direction as shown in FIG. 11. In this regard, there is an H-shaped fulcrum member 190 having a slot 192, slot 192 receiving an edge of support plate 152. Fulcrum member 190 is secured to support plate 152 by means of a bolt 194 which extends through registering holes in adjustable plate 150, one leg of H-shaped fulcrum member 190 and support plate 152, and is threadedly received in a threaded bore 196 in the other leg of H-shaped fulcrum member 190. Adjustable plate 150, as best seen in FIGS. 9 and 11, is also secured to support plate 152 by means of a bolt 198 received in an opening in adjustable plate 150, bolt 198 being threadedly received in a threaded bore in support plate 152. Accordingly, by loosening bolt 194 and tightening bolt 198, support plate 150 can be tilted generally in the direction as shown by arrow Y. Bolt 198 can then be tightened so that the desired position of tube 40 is maintained.

From the description given above and the accompanying drawings it can be seen that the present invention encompasses an apparatus for reducing elongate, stringy, generally metal cuttings or turnings to much shorter chips by first removing the stringy cuttings from or near the workpiece being machined, transferring the stringy cuttings to a chipping assembly which reduces the stringy cuttings to much shorter chips or pieces. Although the invention has been described with respect to a stand, frame or the like for supporting the apparatus adjacent the back side of the head stock of a typical CNC machine such that the conveying portion of the apparatus can extend through the spindle of a CNC machine, it will be understood that if desired, and in lieu of the freestanding arrangement described above, the apparatus could be affixed in a suitable manner to the backside of the headstock of the CNC machine. Other supporting stands could also be employed to support the apparatus of the present invention such that the conveyor extended from the back side of the headstock of the CNC machine through the spindle and chuck.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

1. An apparatus for removing elongate stringy turnings from a workpiece being machined comprising:
an elongate conveyor support having a first end and a second end;
an endless conveyor assembly mounted on said support between a first conveyor mount proximal said first end and a second conveyor mount axially spaced from said first conveyor mount;
a plurality of spaced grapples connected to said conveyor;
said first conveyor mount comprising a first roller engageable with said conveyor;
said second conveyor mount comprising a second roller engageable with said conveyor, at least one of said first and second rollers being a powered roller; and
said first and second conveyor mounts defining first and second axially spaced positions on said conveyor, respectively.

2. The apparatus of claim 1, wherein said first end of said elongate conveyor is selectively positionable proximal said turnings.

3. The apparatus of claim 1, wherein there is a metal chipper assembly mounted proximal said second conveyor mount position and operative to cut said stringy turnings into chips.

4. The apparatus of claim 3, wherein said chipper assembly comprises at least one milling wheel rotatably mounted proximal said second conveyor mount position.

5. The apparatus of claim 4, wherein said chipper assembly further comprises at least one cutting tool having a cutting end proximal said at least one milling wheel.

6. The apparatus of claim 1, wherein said support comprises a U-shaped member extending from said first conveyor position to said second conveyor position, said U-shaped member comprising first and second spaced legs interconnected by a web portion.

7. The apparatus of claim 6, wherein said support further comprises a tubular member in surrounding relationship to said U-shaped member, said U-shaped member being connected to said tubular member.

8. The apparatus of claim 1, wherein said first roller comprises a an idler roller.

9. The apparatus of claim 1, wherein there is a stand connected to and supporting said apparatus.

10. The apparatus of claim 9, wherein said stand comprises at least one stanchion connected to a lower plate and an upper plate, said upper plate carrying an adjustable tube support plate, said tube support plate being connected to said tube.

11. The apparatus of claim 10, wherein said tube is adjustable in X-Y direction axes.

12. The apparatus of claim 1, wherein said powered roller comprises a sprocket and said conveyor comprises a chain.

13. The apparatus of claim 12, wherein said sprocket is mounted for rotation around a generally horizontal axis and said chain has an upper strand and a lower strand, and there is a chain support bar between said upper strand and said lower strand.

14. The apparatus of claim 1, wherein said chain comprises roller links, alternate roller links comprising said grapples.

15. An apparatus for removing elongate stringy turnings from a workpiece being machined comprising:
an elongate conveyor having a first end and a second end, said conveyor being selectively positionable such that said first end is proximal said stringy turnings;
a plurality of grabbing formations formed on said conveyor;
a support for said conveyor; and
a driver connected to said conveyor and operative to move said conveyor such that stringy turnings are grabbed at said first end of said conveyor and transferred along said conveyor to said second end of said conveyor.

16. The apparatus of claim 15, further comprising a metal chipper assembly proximal said second end of said conveyor and operative to cut said stringy turnings into chips.
